(19) United States
(12) Patent Application Publication
(10) Pub. No.: US 2010/0145886 A1
(43) Pub. Date: Jun. 10, 2010

(54) Evaluation and Selection Process for Consumer Products

(75) Inventors: Robert Paul Velthuizen, Trumbull, CT (US); Zhi-xing Jiang, Southbury, CT (US); Jean-Marc Dessirier, Stratford, CT (US); Edwin Ralph Covell, Shelton, CT (US)

Correspondence Address: UNILEVER PATENT GROUP, 800 SYLVAN AVENUE, AG West S. Wing, ENGLEWOOD CLIFFS, NJ, 07632-3100, US

(73) Assignee: CONOPCO, INC., D/B/A UNILEVER, Englewood Cliffs, NJ (US)

(21) Appl. No.: 12/330,231

(22) Filed: Dec. 8, 2008

(51) Int. Cl. G06Q 90/00; A61Q 1/00

(52) U.S. Cl. 705/500; 132/200

(57) ABSTRACT

A product evaluation and selection process for consumer products is described. The process includes demonstrating the effectiveness of consumer product on consumer skin by comparing actual images of skin treated with product to images of skin that were artificially transformed. The process also includes the assignment of a symbol associated with a difference in product performance where the symbol may be used to aid consumers in selecting product.

### FIELD OF THE INVENTION

The present invention is directed to an evaluation and selection process for consumer products. More particularly, the invention is directed to an evaluation process that includes demonstrating the effectiveness of consumer product on a consumer's skin by comparing actual images of skin treated with product to images that were, for example, digitally transformed. The invention also includes the assessment of product differences and the assignment of a symbol associated with the differences in order to assist consumers with the selection of a product.

### BACKGROUND OF THE INVENTION

Many consumers, especially baby boomers, are concerned with their looks. Particularly, consumers are concerned with the characteristics of their skin on and around the face. Skin characteristics, including lightening, darkening, wrinkling, dryness and uneven hyperpigmentation are just some of the characteristics that concern consumers.

Many commercially available skin products are available to consumers and such commercially available products often take months to show a noticeable difference on skin after use. As a result of this, there is a need for a fast and convenient system that assists consumers in comparing products and at selecting products that would be beneficial to them.

The present invention, therefore, is directed to an evaluation and selection process for consumer products. The invention allows for the comparison of product based on information generated by comparing actual images of skin treated with product to images that were, for example, digitally transformed. The invention also includes the assessment of product differences and the assignment of a symbol associated with the differences in order to assist consumers with the selection of product.

### Additional Information

Efforts have been disclosed for evaluating consumer products. In U.S. Pat. No. 6,959,119, described is a method for displaying images of a consumer's skin subjected to digital transforming.

Other efforts have been disclosed for assessing skin color attributes. In U.S. Patent Application No. 2004/0261280 A1, a color ruler device, method and kit are described. In U.S. Patent Application No. 2007/0086651 A1, a method and apparatus for characterizing imperfections of skin are described, and in WO 2008/028893 A1, a method for measuring blemishing on skin is described.

Still other efforts have been disclosed for assessing products. In U.S. Pat. No. 6,734,858, a method for aging an image via an electronic interface to demonstrate a benefit is described.

Even other efforts have been disclosed for assessing skin. In JP 2007-252891 and JP 2002-330943 (abstracts), methods to evaluate skin for age and beauty, respectively, are described.

None of the additional information above describes an evaluation and selection process for consumer products where the process allows for the comparison of product based on information generated by comparing actual images of skin treated with product to images that were altered, for example, digitally. Moreover, none of the information above describes an assessment of product differences associated with a symbol and for the purpose of assisting consumers with the selection of a product.

### SUMMARY OF THE INVENTION

In a first aspect, the present invention is directed to a method for evaluating consumer products comprising the steps of:
(a) analyzing untreated skin of a consumer;
(b) treating the untreated skin with a product to produce treated skin; and
(c) comparing the untreated skin to treated skin

wherein the untreated skin and treated skin are compared to yield a difference associated with a symbol.

In a second aspect, the present invention is directed to a method for evaluating consumer products comprising the steps of:
(a) analyzing untreated skin of a consumer and artificially transforming the untreated skin to a desired result to produce artificially transformed skin;
(b) treating the untreated skin with a product to produce treated skin; and
(c) comparing the treated skin to the artificially transformed skin to yield a difference associated with a symbol.

In a third aspect, the present invention is directed to a method for selling consumer products which includes repeating the method described in the first or second aspect of this invention on a plurality of products, assigning a symbol that is associated with the difference and utilizing the symbol to sell products.

In a fourth aspect, the present invention is directed to assessing skin evenness with blue light transform.

Analyzing, as used herein, means assessing, for example, by visually studying a portion of skin with or without a visual aid such as a magnifying glass. Analyzing also includes the digital analysis of skin by using, for example, photography and image analysis. Such analyzing is meant to be directed at skin traits or characteristics which include evenness of color, beauty, radiance, glow, texture, naturalness, pore size as well as moisture content. Skin, as used herein, is meant to include skin on the face, neck, chest, back, arms, hands, legs, scalp, feet, buttocks and abdomen. Artificially transformed means modified by a process that does not include using an active to produce an intended result. Artificially transformed, therefore, does include applying a cover-up such as a make-up to create a desired end result, or using image transformation that includes, for example, light, lenses, mirrors and/or digital transformation to create a desired look. The transformation may be made to the skin itself, to a photo image of the skin and/or both. Symbol, as used herein, means an identifier that includes a number, shape, emblem or the like that may be used to identify a difference, and particularly, the perceived difference between the performance of one product against another product in comparison to artificially transformed skin. Such a symbol may be used in advertisements (written and/or oral) as well as on a product. Blue light transform, as used herein, means the utilization of blue light (i.e., light having or wavelength from about 440 to about 490 nm) to transform an image of skin, including a photograph thereof, by adding red light (i.e., light having a wavelength from about 630 to about 670 nm) thereto. Evenness, as used herein, means the spatial homogeneity of skin color. Images of skin means an image created by observing skin or a reproduction thereof such as a photographic reproduction. Treated with a product includes product topically applied, ingested, injected, product applied via radiation with visible light or ultraviolet radiation or both, as well as product applied or resulting from treatment with a physical device such as those that employ microneedles or ultrasound. Product, as used herein, includes products to leave on skin as well as products to wash off. Comprising, as used herein, is meant to include consisting essentially and consisting of. Unless specifically stated otherwise, all ranges defined are meant to include all ranges subsumed therein.

### DETAILED DESCRIPTION OF THE PREFERRED EMBODIMENTS

The only limitation with respect to the type of skin characteristic that may be assessed with this invention is that the characteristic is of the type typically of concern for humans. When practicing the present invention, untreated skin, typically on the human body and preferably on the face, is assessed and analyzed for a targeted characteristic, like evenness of color, before being treated with a product or regimen designed to improve color evenness. The assessment may be of the skin directly or a photograph thereof. Panelist involved in the assessment may be asked a series of questions (i.e., surveyed) generally related to the targeted skin characteristic, where such questions may, for example, relate to the panelist's height, weight, gender, sex, age, diet, nationality, skin condition and/or desired skin improvements.

The information collected from the assessment, including any answer or answers provided during the survey, may, for example, result in a recommended product for the panelist to utilize in order to improve the targeted characteristic, like evenness of color. Subsequent to utilizing the product recommended, the resulting treated skin is assessed for product efficacy and overall performance. Any and all information generated pre- and post-treatment may be stored and maintained, preferably, in a database and can be used in association with a symbol to market products.

Typically, when product is used to yield treated skin, the product is used once, or for a period from about one (1) minute to about twelve (12) months, and most preferably, for a period from about two (2) minutes to about four (4) months, including all ranges subsumed therein. In addition to the above, the untreated skin or any photo or image thereof can be artificially transformed independent of using product to yield a desired consumer result as it relates to the targeted characteristic. In a preferred embodiment, the results from the artificial transformation are then compared to the results from the assessment of the treated skin. In a most preferred embodiment, skin targeted for analysis is artificially transformed independent of being treated so that the treated skin and artificially transformed skin originate from the same position/body part of the panelist. The assessment may be conducted by the panelist and thereby be a self assessment study or be conducted by individuals that can be observers that may or may not have been subjected to product or trained graders that are not panelists having their skin subjected to product and artificial transformation but are individuals with training and experience in assessing skin.

When assessing product, typically at least about ten (10) panelists, and preferably, from about 15 to about 150 panelists, and most preferably, from about 50 to about 100 panelists participate in the evaluation of a single product. When, for example skin lightening products from competitors are being assessed, it is preferred that the assessments made or generated are the result of different products being applied to the same panelist. A first product, therefore, may be applied to, for instance, the right cheek of a panelist and a second product may be applied to the left cheek of the same panelist. Product A would thus be compared to product B by applying product to corresponding areas of skin of at least about ten (10) panelists. This allows for very accurate bilateral comparisons. In a preferred embodiment, at least two products targeted for an identical characteristic are compared, and most preferably, from about two (2) to about ten (10) products targeted for an identical characteristic are compared. In yet another preferred embodiment comparisons are made between skin at multiple time points (e.g., between 0-30 weeks, preferably 0-20 weeks) during treatment with the artificially transformed skin at multiple transform levels (e.g., 7-12% or 13-18%).

The product employed in this invention is limited only to the extent that it may be used with humans. Such a product can comprise, for example, skin lightening agents like niacinamide, and/or hydroquinone, resorcinols and its derivatives, retinoids, conjugated linoleic acid, petroselinic acid, alpha-hydroxy acids, beta-hydroxy acids, peroxides, fragrances, plant extracts, surfactants, humectants, thickeners, water, silicones, solvents, sunscreens, vitamins other than niacinamide, tea or tea solids, anti-acne agents, preservatives and any art recognized combination thereof.

It is within the scope of this invention to assign a symbol associated with the efficacy or performance of each product tested, and it is preferred that the untreated skin is artificially transformed to a desired result of the consumer (i.e., panelist) and compared to the actual results obtained by using product. For illustrative purposes and clarity, a consumer/panelist may select a particular facial trait, like evenness of color around the cheeks that he or she would like to improve. Artificial transformation may be employed on one or both of the cheeks of the consumer to yield a desired result. Subsequently, products of one company should be employed on one cheek of the panelist and the product of a second company on the opposite cheek of the same panelist. The results obtained may then be compared to the artificially transformed skin selected to mimic a desired result identified by the panelist. Subsequent to all panelists completing the regimen and the comparison of treated skin to the desired artificially transformed skin, the results obtained may be statistically analyzed to result in a perceived difference (delta) that may be used in advertising and to sell product.

In a preferred embodiment, the results obtained are generated by asking the panelists, observers or graders pointed questions in a two-alternative forced choice task. Such panelists or graders may be asked, for example, which image has more even color or which image has less wrinkles and pores? In another preferred embodiment, the results are generated by using conventional image analysis methods (e.g., like those made commercially available by Media Cybernetics and ITT Visual Information Solutions) on both transformed images from artificially transformed skin and images of treated skin.

The data analysis which may be employed in this invention is limited only to the extent that it is generally recognized when assessing consumer products and provides a numerical estimate of the perceived difference between the treated and transformed skin. Illustrative examples include D-prime, R-Index, Cohen's D and T-statistic.

As to the artificial transformation of untreated skin, the same may be achieved by digitally transforming an image as described in U.S. Pat. No. 6,959,119 B2, as well as by using averaging techniques as described in Prototyping and Transforming Facial Textures for Perception Research, IEEE computer Graphics and Applications, Vol. 21, pp. 42-50, 2001, the disclosures of which are incorporated herein by reference. In a preferred embodiment, the characteristic targeted in this invention is evenness of skin color. In another preferred embodiment, the artificial transformation of such unevenly colored skin is achieved by using blue light and introducing through image arithmetic red light into the blue light channel to create the desired artificially transformed image. Typically, this method, identified herein as blue light transform, will require from about 0.5 to about 60%, and preferably, from about 3 to about 40%, and most preferably, from about 6 to about 30% red light in the blue light channel, including all ranges subsumed therein.

The output or perceived difference obtained in this invention and resulting from the assessment defined herein may be associated with a symbol in order to convey to a consumer the perceived difference between how a particular product performs against another product. To illustrate, if product A and product B are to be assessed for their ability to improve skin texture, every panelist involved would have her untreated skin analyzed and artificially transformed to a look suitable to her liking, where the artificial transformation is equally applied to each panelist.

Subsequent to being treated with product A and B (i.e., an identical regimen for each panelist), the perceived difference in skin treated with product and the artificially transformed skin results in a symbol. A one (1) or star, for example, can mean the product resulted in skin very close to the look of the artificially (highly desirable) transformed skin. A five (5) or a square can mean the product resulted in skin which was about fifty (50) percent improved when compared to artificially transformed skin. A zero (0) or a circle can mean no improvement when comparing treated skin to untreated skin and/or the artificially transformed skin.

The symbols used and the products associated with such symbols may be described in any art recognized advertisement, such as a magazine advertisement or in a television or radio commercial. Such symbols may be marked on the product of the company utilizing this invention whereby the consumer can connect with the symbol if he or she is familiar with the advertisement. Alternatively, a key or advertisement may be placed near product at a store so that a consumer can connect with the symbol prior to making a purchase.

The Examples are provided to facilitate an understanding of the invention. The Examples are not intended to limit the scope of the claims.

### Example 1

Forty-nine (49) panelists were subjected to blue light transform in order to yield facial images having a desired evenness of color (i.e., artificially transformed skin). The transform was achieved by blending 10% and 18% red channel into blue channel. Product, comprising hydroquinone (4%), was prescribed by a dermatologist to the forty-nine (49) panelists. The product was home-used once a day for twelve weeks and applied to the face of the panelists. After completion of product application, the panelists evaluated their photographs in a forced-choice experiment. At zero (0) weeks (i.e., before initial application of product) the 10% and 18% transforms had D-prime values of about 1.4 and 2.3, respectively, when compared to untreated skin. After five (5) weeks of treatment, the 10% and 18% transforms had D-prime values of about 0.6 and 1, respectively, when compared to the treated skin. After eight (8) weeks of treatment, the D-prime values for the 10% and 18% transforms were 0.1 and 0.6, respectively. At twelve (12) weeks, essentially no difference could be seen between the treated skin and the artificially transformed skin (10% and 18%). The D-prime values obtained herein may be used to create a system with symbols to assist in the marketing and advertising of consumer products, such as skin lightening products. After fitting a bi-linear model with transform level and time point as independent variables, it was seen that at twelve (12) weeks the product tested achieved the effect of a 13% blue light transform.

### Example 2

The procedure in Example 2 was performed in a manner similar to the one described in Example 1 except that two commercially available and non-prescription skin whitening products were assessed in a test where each was applied to opposite sides of a panelist's face. Forced-choice (self assessment) between photographs after twelve (12) weeks treatment and transforms were achieved with blue light transform and by blending 14% red channel into the blue channel. The D-prime values obtained for each product were about 0.4 after twelve (12) weeks of treatment, indicating that the products had similar skin lightening performances after twelve (12) weeks. Such D-prime values may be used to create a system with symbols to assist in the marketing and advertising of consumer products of non-prescription consumer products.

What is claimed is:

1. A method for evaluating at least one product comprising the steps of:
(a) analyzing untreated skin of a consumer and artificially transforming the untreated skin to a desired result to produce artificially transformed skin;
(b) treating the untreated skin with a product to produce treated skin; and
(c) comparing the treated skin to the artificially transformed skin
wherein the treated skin and artificially transformed skin are compared to yield a difference and the difference is associated with a symbol.

2. The method for evaluating at least one product according to claim 1 wherein the product is a leave on or wash off product.

3. The method for evaluating at least one product according to claim 1 wherein the untreated, treated and artificially transformed skin are analyzed visually, by image analysis or through photographs.

4. The method for evaluating at least one product according to claim 1 wherein the untreated skin is artificially transformed with digital transformation, or with transformation that uses light, lenses, a mirror, make-up or the morphing of a photograph.

5. The method for evaluating at least one product according to claim 1 wherein the untreated skin is treated with a product that is suitable to be injected, ingested, topically applied, applied using radiation or applied with a physical device.

6. The method for evaluating at least one product according to claim 1 wherein the product is a skin lightening product that comprises niacinamide.

7. The method for evaluating at least one product according to claim 2 wherein the difference is statistically analyzed with D-prime analysis.

8. The method for evaluating at least one product according to claim 1 wherein at least two consumer products are evaluated and compared to artificially transformed skin.

9. The method for evaluating at least one product according to claim 1 wherein the product is evaluated for yielding evenness of skin color.

10. The method for evaluating at least one product according to claim 1 wherein the untreated skin is assessed for evenness of color and artificially transformed with blue light transform.

11. A method for marketing or selling a product comprising the steps of:
(a) analyzing untreated skin of a consumer and artificially transforming the untreated skin to a desired result to produced artificially transformed skin;
(b) treating the untreated skin with a product to produce treated skin;
(c) comparing the treated skin and artificially transformed skin to yield a difference associated with a symbol; and
(d) using the symbol on product, with an advertisement, or both to market and/or sell products.

12. The method according to claim 11 wherein a plurality of products are analyzed and all differences generated are associated with a symbol for a consumer to rely on prior to making a purchase.

13. The method according to claim 11 wherein the product is a topically applied consumer product.

14. The method according to claim 11 wherein the untreated skin is artificially transformed with blue light transform.

15. A method for transforming a photograph of untreated skin for improved evenness of color, comprising the steps of:
(a) identifying skin to be treated; and
(b) subjecting the photograph of untreated skin to blue light transform by blending red light into a blue light channel.

16. The method according to claim 15 wherein from about 0.5 to about 60% red light is blended into the blue light channel.

17. A method for evaluating consumer products comprising the steps of:
(a) analyzing untreated skin of a consumer;
(b) treating the untreated skin with a product to produce treated skin; and
(c) comparing the untreated skin to treated skin
wherein the untreated skin and treated skin are compared to yield a difference associated with a symbol.
